(19) United States
(12) Patent Application Publication
(10) Pub. No.: US 2023/0150157 A1
(43) Pub. Date: May 18, 2023

(54) ROTARY ELECTRIC SHAVER

(71) Applicant: IZUMI PRODUCTS COMPANY, Matsumoto (JP)

(72) Inventors: Tsuyoshi NAKANO, Matsumoto (JP); Yoshiyuki Mimura, Matsumoto (JP)

(73) Assignee: IZUMI PRODUCTS COMPANY, Matsumoto (JP)

(21) Appl. No.: 18/155,123

(22) Filed: Jan. 17, 2023

Related U.S. Application Data
(63) Continuation of application No. 16/113,469, filed on Aug. 27, 2018, now abandoned.
Application No. 16/113,469 is a division of application No. 13/290,761, filed on Nov. 7, 2011, now abandoned.

(30) Foreign Application Priority Data
Nov. 8, 2010 (JP) 2010-249420

(51) Int. Cl. B26B 19/14

(52) U.S. Cl. CPC B26B 19/143

(57) ABSTRACT

A rotary electric shaver includes an outer cutter which has an upper surface with annular shaving faces, in which many hair-entry apertures are formed, and an inner cutter having small blades, which rotate in sliding contact with the lower surface of the outer cutter from below the shaving faces. The outer cutter (10) has a plurality of concentric annular shaving faces (16, 18), which are integrally formed therewith. The density of the hair-entry apertures (65) is varied in the circumferential direction of the plurality of annular shaving faces (16, 18). The rotary electric shaver increases the shaving area of the outer cutter to improve shaving efficiency and also restrains excessively close shaving thereby to protect skin even when the contact pressure of an area near the center of the outer cutter against skin increases.

This application is a continuation of U.S. application Ser. No. 16/113,469 filed Aug. 27, 2018, which is a divisional of U.S. application Ser. No. 13/290,761, filed Nov. 7, 2011, which claims priority to Japanese Patent Application No. 2010-249420, filed Nov. 8, 2010, each of which is incorporated herein by reference in its entirety.

### BACKGROUND OF THE INVENTION

### Field of the Invention

The present invention relates to a rotary electric shaver and, more particularly, to a rotary electric shaver having an outer cutter, which has annular shaving sections or faces with many hair-entry apertures formed therein, and an inner cutter having small blades which rotate in sliding contact with the outer cutter from below the shaving faces.

### Description of the Related Art

This type of rotary electric shaver is required to be capable of enabling an approximately disc-shaped outer cutter thereof to minutely trace the fine irregularities of skin surface according to the characteristics of beard, which differ from user to user, so as to smoothly shave the beard without leaving any unshaved places. For example, there is a problem in that chances of leaving unshaved areas tend to increase in a markedly uneven skin surface, such as an area under the jaw of a user or a wrinkled skin. Further, pressing the outer cutter excessively firmly against the skin surface could result in excessively close shaving, damaging the skin.

JP 2000-509628(A) (corresponding to WO 98/35794 and US 2001/0039734A1) discloses a shaving apparatus having a plurality of outer cutters, each of which has a single annular shaving face (also referred to as a single track). The patent discloses outer cutters having different densities of apertures serving as hair-entry apertures in the annular shaving faces thereof (an aperture ratio, which is the ratio of the aperture area with respect to a shaving area, i.e., (aperture area)/(shaving area)). In one type, the aperture density decreases toward the center (in the vicinity of a portion wherein the plurality of outer cutters is close to each other) of a cutter frame (outer cutter frame), while in another type, the aperture density increases toward the center. More specifically, the outer cutters have different types of hair-entry apertures (hair input apertures), including a type for cutting long hair and another type for cutting short hair, the same type of shaving faces of different outer cutters being disposed at positions where they face each other.

JP 2006-510430(A) (corresponding to WO 2004/056539 and U.S. Pat. No. 7,269,902B and EP 1578567A1) discloses shaving apparatuses in which each of the plurality of outer cutters in JP 2000-509628(A) is made rotative and the outer cutters rotate such that the hair-entry apertures of the same type in different outer cutters are disposed in positions where they face each other (adjacently to the center of the cutter frame). More specifically, the outer cutters are rotatively moved by a frictional force produced when inner cutters rotate, and projections provided on the outer peripheries of the outer cutters are abutted against control members, thereby fixing the positions thereof in the direction of rotation of the outer cutters. In this case, the control members are engaged with or disengaged from the projections to change the rotating positions of the outer cutters.

JP 2004-515283(A) (corresponding to WO 02/45920A1 and U.S. Pat. No. 6,868,611B) discloses a shaving apparatus in which the upper surface of a decorative cover (a skin support area) installed at the center adjacent to the inner periphery of an annular outer cutter shaving face is provided with ridges in a partial angular area in the peripheral direction close to the inner periphery of the outer cutter shaving face. The ridges reduce the contact pressure of the shaving face against skin, thereby protecting skin. More specifically, the ridges push the skin that comes in contact the ridges in a direction away from the shaving face to reduce the contact pressure of the shaving face close to the outer side of the ridges.

All the shaving apparatuses disclosed in the three patents described above has a single annular shaving face or section in the outer cutter thereof, posing a problem of significant limitation in increasing the shaving area with resultant limited improvement in shaving efficiency. The shaving area could be increased by providing double (multiple) annular shaving faces. In this case, however, since a skin surface normally bulges out, vertically pressing the upper surface of the outer cutter against the skin would cause the portion near the center of the outer cutter, that is, the inner annular shaving face, to be firmly applied to the skin. Hence, especially when the contact pressure of the outer cutter is increased, a problem could arise in that the inner annular shaving face leads to excessively close shaving, damaging the skin.

According to the one disclosed in JP 2000-509628(A), the hair-entry apertures of the same type in the plurality of outer cutters are disposed in opposing positions. If multiple shaving faces are formed in each of the outer cutters, then the contact pressure in the vicinity of the center of each outer cutter will increase, leaving the aforesaid problem unsolved.

According to the one disclosed in JP 2006-510430(A), the plurality of outer cutters could be rotated simultaneously and control could be carried out such that the shaving faces of the same type of the outer cutters oppose each other. However, firmly pressing the plurality of outer cutters vertically against flat skin at the same time would cause an increase in the contact pressure in the vicinity of the center of each outer cutter, leading to the same problem as that described in the JP 2000-509628(A). According to the JP 2004-515283(A), the ridges provided on the central decorative cover (the skin support area) limit the increase of the shaving area, thus limiting the improvement in the shaving efficiency.

### SUMMARY OF THE INVENTION

The present invention has been made with a view of the background described above, and it is an object of the invention to provide a rotary electric shaver capable of increasing the shaving area of an outer cutter to improve shaving efficiency and preventing excessively close shaving thereby to protect skin surface even if the contact pressure applied to the skin from the vicinity of the center of an outer cutter increases when the outer cutter is firmly pressed vertically against the skin.

According to the present invention, the object is fulfilled by a rotary electric shaver including an outer cutter, an upper surface of which has annular shaving faces with a plurality of hair-entry apertures formed therein, and an inner cutter having a small blade which rotates in sliding contact with a lower surface of the outer cutter from below the shaving face, wherein the outer cutter has a plurality of concentric annular shaving faces integrally formed, and the density of the hair-entry apertures varies in the circumferential direction of the plurality of annular shaving faces.

According to the present invention, the plurality of concentric annular shaving faces or sections are formed on the upper surface of the outer cutter, so that the shaving area is increased to permit improved shaving efficiency. An electric shaver is usually used by moving it in contact with skin (slid on the surface of skin), so that slightly moving the outer cutter will cause shaving faces of different aperture densities to come in contact with the same area of skin in sequence or repeatedly. At this time, the aperture densities of the plurality of shaving faces vary in the circumferential direction, so that the shaving faces of different aperture densities will come in contact with the same place of the skin in sequence or repeatedly by slightly moving the outer cutter relative to the skin or slightly rotating a grip or a main unit about the outer cutter to move the position of the contact of the outer cutter on the surface of the skin. Thus, even when the outer cutter is brought into firm contact with the outer cutter, the chances of damaging the skin due to excessively close shaving will be minimized, because the area in which the aperture density is high will not be in constant contact.

The annular shaving faces or sections formed in the outer cutter may be arranged in two concentric circles or three or more concentric circles. To change the aperture density in the circumferential direction, two or more areas wherein the density of the hair-entry apertures is minimal may be provided at equiangular intervals around the annular shaving face. The portions with the minimum aperture density may be formed of smooth metal surfaces (blanks) free of apertures. In this case, the blanks are provided at two or more locations at equidistant intervals in the circumferential direction. In place of the blanks, areas with an extremely low aperture density may be provided. The blanks or the areas with an extremely low aperture density allow highly smooth slide on a skin surface. Hence, excessively close shaving will be restrained, thus maximizing the advantages of the present invention by moving the outer cutter.

To vary the aperture density in the circumferential direction, a full annular shaving face may be circumferentially divided into two or more equal segments and the aperture density within the angular range of each of the equal segments may be continuously changed in a fixed rotational direction. This is ideal for a user who has a habit of rotating a shaver while laterally swinging the grip with the outer cutter thereof applied to his skin surface. More specifically, such a habit causes the aperture density of the portion that comes in contact with a shaving portion of skin to constantly change in continuity as the outer cutter is moved, so that excessively close shaving is restrained while maintaining smooth shaving, thus permitting protection of the skin.

Arranging changes in the density of the hair-entry apertures, which are provided in an outer periphery annular shaving face and an inner periphery annular shaving face, in the circumferential direction automatically arranges changes in the aperture densities on the outer peripheral side and the inner peripheral side in a radial direction, thus further maximizing the advantages. For example, arranging the blank areas on the outer peripheral side and the inner peripheral side in the radial direction leads to smoother slide of the outer cutter, so that chances of excessively close shaving can be minimized, resulting further improved protection of skin.

The density of the hair-entry apertures formed in the shaving face on the outer peripheral side is preferably higher than the density of the hair-entry apertures formed in the shaving face on the inner peripheral side. This is because the danger of excessively close shaving or damaging skin by the hair-entry apertures on the outer peripheral side is reduced even if the contact pressure on the inner peripheral side increases when the outer cutter is pressed against a convex portion of skin.

The hair-entry apertures in the shaving faces of the outer cutter may be in the form of slits. The slits can be efficiently formed in all the annular shaving faces in a single step by moving a rotary disk grindstone, which rotates about a horizontal axis, in the radial direction of the outer cutter (the annular shaving faces) or by moving it while slightly tilting it in the radial direction (substantially in the radial direction) when machining the outer cutter, which will be discussed hereinafter. The directions of the slits do not necessarily have to be precisely the radial direction of the outer cutter, and may be at an angle relative to the radius, which will be referred to also as the radial direction.

Setting the angles of the slit intervals in the circumferential direction in the shaving face on the outer peripheral side to be smaller than those of the slit intervals in the shaving face on the inner peripheral side makes it possible to set the density of the hair-entry apertures formed in the shaving face on the outer peripheral side to be higher than the density of the hair-entry apertures formed in the shaving face on the inner peripheral side.

For example, the aperture density of the shaving face on the outer peripheral side can be increased by providing common hair-entry slits positioned on a common straight line and formed on the inner periphery shaving face and the outer periphery shaving face, respectively, and a non-common hair-entry slit on the outer peripheral side that is formed in the outer periphery shaving face and positioned between the common hair-entry slits. In this case, using the same opening width of the slits allows the same machining tool (e.g., a rotary disk grindstone) to be conveniently used. Alternatively, however, the opening width of the slits may be varied.

Setting the shaving face on the outer peripheral side and the shaving face on the inner peripheral side to have different heights in the direction of the rotational axis of the inner cutter makes it possible to obtain a proper pressure of contact with skin. For example, setting the shaving face on the inner peripheral side to be higher than the shaving face on the outer peripheral side in the direction of the rotational axis of the inner cutter makes it possible to increase the skin contact pressure of the shaving face on the inner peripheral side, and smooth slide is ensured because of the lower aperture density of the shaving face on the inner peripheral side. Thus, excessively close shaving can be restrained to protect skin. Conversely, if the shaving face on the inner peripheral side is set to be lower than or substantially the same height as the shaving face on the outer peripheral side in the direction of the rotational axis of the inner cutter, then proper contact with a convex portion of skin can be accomplished.

As described above, further versatile shaving features can be obtained by changing the aperture densities on the outer peripheral side and the inner peripheral side in addition to using different aperture densities in the circumferential direction on the inner peripheral side and the outer peripheral side of the outer cutter, or combining the different heights of the outer periphery annular shaving face and the inner periphery annular shaving face, respectively. This enables the shaver to be adapted more properly to user's preferences and other characteristics, including the type of his beard.

### BRIEF DESCRIPTION OF THE DRAWINGS

FIG. 1 is a perspective view illustrating the appearance of a rotary electric shaver according to an embodiment of the present invention;

FIG. 2 is a diagram illustrating a layout example of hair-entry apertures of an outer cutter of the electric shaver in FIG. 1;

FIG. 3 is a sectional view of a cutter assembly of the electric shaver in FIG. 1;

FIG. 4 is a partial enlarged sectional view of the outer cutter shown in FIG. 3 and illustrates the machining method of slits;

FIG. 5 is a sectional view illustrating the grinding/abrading method of an outer cutter according to the embodiment of the present invention;

FIG. 6 is a sectional view illustrating the grinding/abrading method of an inner cutter according to the embodiment of the present invention; and

FIG. 7 is a diagram illustrating the layout of hair-entry apertures of an outer cutter of a rotary electric shaver according to another embodiment of the present invention.

### DESCRIPTION OF THE PREFERRED EMBODIMENTS

### First Embodiment

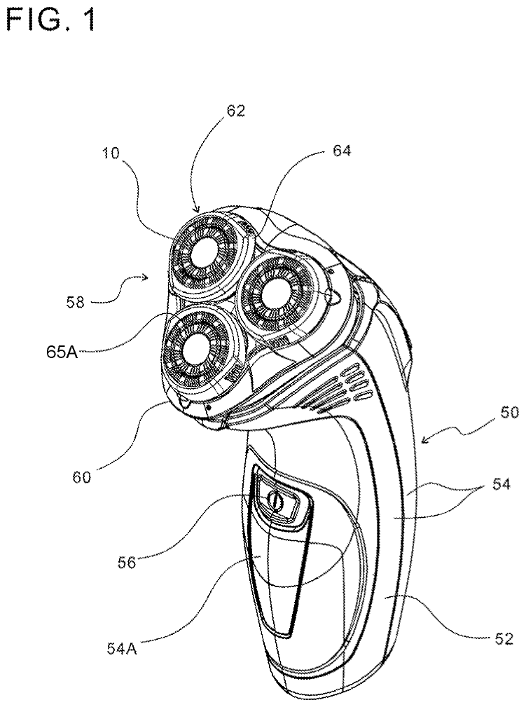

Referring to FIG. 1, a main body 50 has a case 54 formed by curving an upper portion of a grip 52, which is approximately columnar, diagonally upward to the front. The case 54, which can be split into a front counterpart and a back counterpart, houses a chargeable battery, an electric motor, a control circuit board and the like (not shown). A power switch 56 is attached to the front surface of the case 54. A display (not shown) composed of LED lamps indicating the amount of remaining charge of the battery, an operation status and the like is located under the switch 56. The display can be seen from outside through a translucent portion 54A of the case 54.

A head unit 58 is openably and detachably attached to an upper portion of the case 54. The head unit 58 is inclined relative to the grip 52 of the case 54 such that the shaving faces (the upper surface of a cutter frame 60, which will be discussed later) are directed diagonally upward to the front. The electric motor has its rotation output shaft protruded from the upper surface of the case 54 into the head unit 58, rotatively drives an inner cutter 12, which will be discussed later, and elastically pushes up the inner cutter 12 upward thereby to properly maintain the contact pressure of small blades 22 and 24 against the lower surfaces of shaving faces 16A and 18A.

The head unit 58 has the cutter frame (outer cutter frame) 60 openably attached to the upper face of the case 54, and three sets of cutter assemblies 62 are installed to the cutter frame 60. The cutter frame 60 is approximately triangular in a planar view, the peripheral edge thereof being gently curved downwards. The cutter frame 60 has three circular mounting ports in which the cutter assemblies 62 are movably retained such that they may be tilted and also exhibit the habit of returning upwards.

More specifically, each of the cutter assemblies 62 includes an outer cutter 10 which has a substantially discoid shape and the periphery of which is bent downwards, an outer cutter rim 64 in which the outer periphery of the outer cutter 10 is fitted (FIG. 1), and an inner cutter 12 which is in sliding contact with the outer cutter 10 from below (FIG. 3). The inner cutter 12 is rotatively retained on the cutter assembly 62 such that it does not come off downwards and is rotatively driven by the electric motor, as described above.

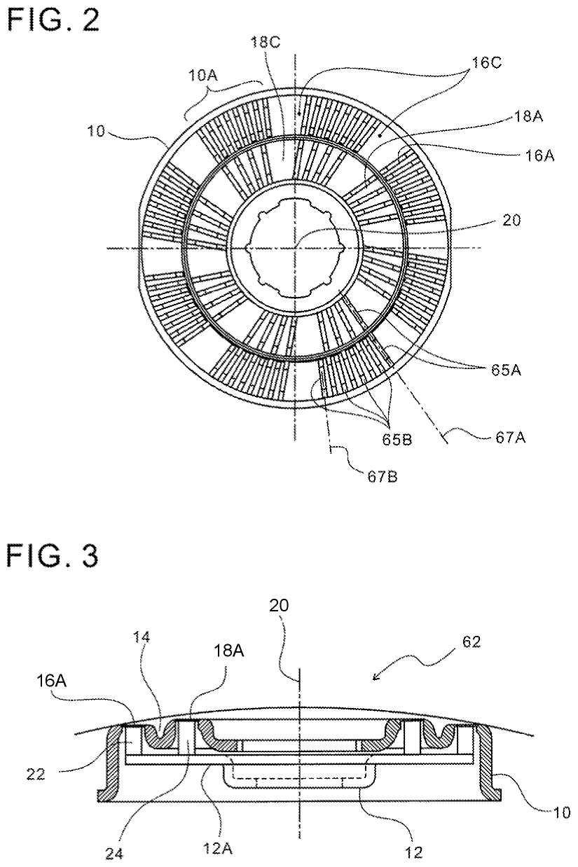

The upper surface of the outer cutter 10 has an annular groove 14 formed concentrically with a central axis 20 and two annular shaving sections or faces 16A and 18A formed on an outer side and an inner side of the annular groove 14, as illustrated in FIGS. 2 and 3. Referring to the two annular shaving faces 16A and 18A, the inner periphery shaving face 18A is taller than the outer periphery shaving face 16A along the central axis 20, and these shaving faces 16A and 18A are positioned on planes horizontal to the central axis 20. In other words, these shaving faces 16A and 18A are positioned on horizontal planes which have different heights along the central axis 20.

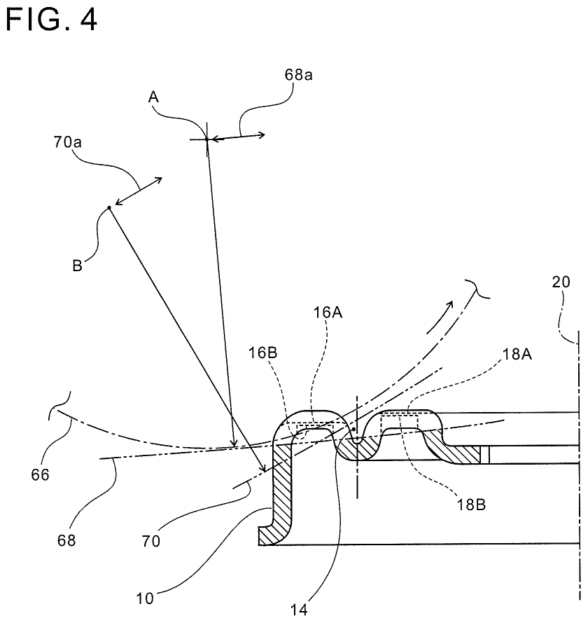

As illustrated in FIGS. 1 and 2, formed in the outer cutter 10 in the radial direction are many slits 65A and 65B, which provide hair-entry apertures, the upper surface of the outer cutter 10 projecting out beyond the outer cutter rim 64. The slits 65A are formed by a rotary disk grindstone 66, as illustrated in FIG. 4. More specifically, a metal sheet (metal material) that is to be turned into the outer cutter 10 is pressed to form the two annular shaving faces 16A and 18A and the annular groove 14 positioned therebetween, and then the rotary disk grindstone 66 cuts in the portions of the pressed metal material which are to be formed into the annular shaving faces 16A and 18A, from above, leaving the annular groove 14 intact. At this time, the rotary disk grindstone 66 is moved substantially in the radial direction while being rotated with the outer periphery thereof set vertically. The rotary disk grindstone 66 is a thin disc-shaped tool made by dispersing wear-resistant particles, such as diamond abrasive grains, in the abrasive grains, which are then hardened.

First, the rotary disk grindstone 66 forms the two annular shaving faces 16A and 18A at the same time to a depth along a first machining line 68 in FIG. 4. More specifically, a center of rotation A of the rotary disk grindstone 66 is moved substantially in the radial direction (in the direction of a movement line 68a in FIG. 4) such that the outer periphery (cutting edge) of the rotary disk grindstone 66 moves along a first machining line 68. To form only the slits 65B in the outer peripheral annular shaving face 16A selectively deeply, the center of rotation A is moved to position B so as to cause the outer periphery of the rotary disk grindstone 66 to move along a second machining line 70 shown in FIG. 4, and then the center B is moved substantially in the radial direction along a movement line 70a parallel to the second machining line 70.

In the present embodiment, the aperture density (aperture ratio) of the annular shaving face 18A on the inner peripheral side is lower than the aperture density of the annular shaving face 16A on the outer peripheral side. More specifically, the slits 65A on the inner peripheral side and the slit 65A on the outer peripheral side are formed as common linear slots (common hair-introduction slits) on a common straight line 67A (FIG. 2) by machining along the first machining line 68 in FIG. 4, and non-common linear slits (non-common hair-introduction slits) 65B are formed along the second machining line 70 on non-common straight lines 67B only in the outer periphery shaving face 16A. In this case, the same rotary disk grindstone 66 can be used for machining the slits 65A and 65B, which share the same aperture width.

If the non-common linear slits 65B are formed one each between the common linear slits 65A, then the number of the slits in the outer periphery shaving face 16A will be double the number of the slits in the inner periphery shaving face 18A, provided that there are an even number of the common linear slits 65A. Thus, the aperture density on the outer peripheral side can be made higher than the aperture density on the inner peripheral side.

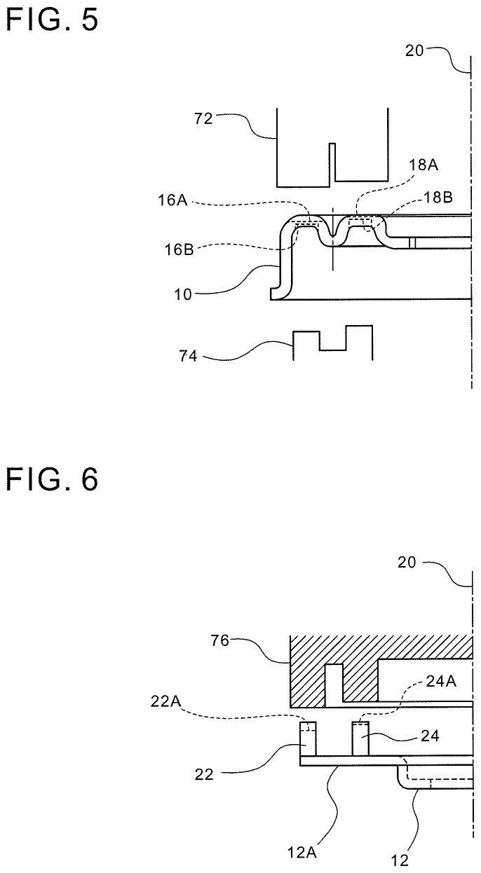

In this state, the portions which are to be formed into the annular shaving faces 16A and 18A have the thickness of the metal sheet of the outer cutter 10, and will be machined to sufficiently thin annular shaving faces 16A and 18A (FIG. 5) by grinding the portions corresponding to the annular shaving faces 16A and 18A in the next step or by polishing the portions thereafter. The upper surfaces of the shaving sections 16A and 18A can be machined by rotating a grinding tool, such as a turning tool, or a abrasive tool (referring also to a grinding/abrasive tool to include both) 72, such as a grindstone, about the central axis 20. The tool 72 has a step corresponding to the difference in height between the annular shaving faces 16A and 18A, as illustrated in FIG. 5.

Further, the lower surfaces of the annular shaving faces 16A and 18A can be machined by rotating a grinding/abrasive tool 74, which has a step corresponding to the difference in height therebetween, about the central axis 20 in the same manner as described above. Referring to FIG. 5, the dashed lines 16A and 18A denote the upper surfaces of the shaving faces (the surfaces to come in contact with skin) and the dashed lines 16B and 18B denote the lower surfaces of the shaving faces (the surfaces against which the small blades 22 and 24 of the inner cutter 12 slide, that is, the sliding surfaces of the inner cutter). It is needless to say that the outer cutter 10 may be rotated instead or together when the grinding/abrasive tool 72 or 74 is rotated.

Referring to FIG. 3, in the inner cutter 12, the small blades 22 and 24, which slidably contact with the lower surfaces (the inner cutter sliding surfaces) 16B and 18B of the shaving faces 16A and 18A, are integrally formed on a same metal plate 12A. The upper edges of the small blades 22 and 24 slidably contact with the lower surfaces 16B and 18B, which are the inner cutter sliding surfaces, to cut the hair that enters the slits 65A. It is necessary, therefore, to match the heights of the upper edges with the heights of the inner cutter sliding surfaces 16B and 18B and also to abrade them so as to improve their sharpness beforehand. For this purpose, the metal plate 12A, which is to be formed into the inner cutter, can be machined by relatively rotating a grinding/abrasive tool 76 (FIG. 6), which has a step corresponding to the height difference, about the central axis 20. Dashed lines 22A and 24A in FIG. 6 indicate the upper edges (blade surfaces) machined by the grinding/abrasive tool 76.

In the present embodiment, the slits 65A are laid out unevenly in the circumferential direction. As illustrated in FIG. 2, the outer periphery shaving face 16A and the inner periphery shaving face 18A have areas with a lower aperture density, such as smooth areas free of slits (blanks or areas 16C and 18C with an extremely low slit density), provided at eight locations at predetermined intervals in the circumferential direction of the shaving faces 16A and 18A. The outer periphery blank areas 16C and the inner periphery blank areas 18C are radially arranged in the circumferential direction. Hence, the blank areas 16C and 18C do not cause deteriorated smoothness on skin, permitting improved shaving smoothness especially when moving the outer cutter 10 parallel to skin.

In areas 10A between the blanks 16C and 18C, the densities of the slits 65A in the circumferential direction are fixed. Further, the number of the slits 65A on the inner peripheral side is smaller than the number of the slits 65A on the outer peripheral side (the former is half the latter in the embodiment illustrated in FIG. 2), thus minimizing the danger of causing damage to skin even if the pressure of contact with skin increases because of the inner shaving face 18A being higher than the outer shaving face 16A.

### Second Embodiment

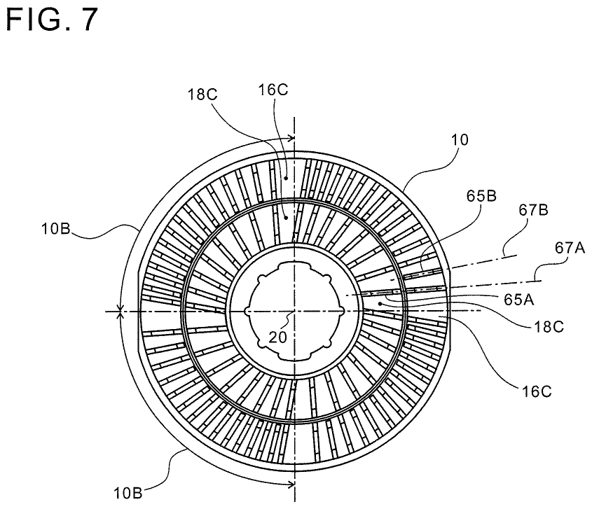

FIG. 7 illustrates a second embodiment, in which shaving faces 16A and 18A of each of outer cutters 10 are divided into four segments 10B in the circumferential direction. In each of the areas 10B, the density of slits 65A and 65B is gradually changed in the circumferential direction. As shown in FIG. 7, the spacing of slits 65A and 65B vary in the circumferential direction. In this embodiment, the slit density has been gradually changed from high to low in the circumferential direction. Further, in an inner periphery shaving face 18A and an outer periphery shaving face 16A, areas with low slit densities (smooth blank areas free of slits) 16C and 18C are radially arranged in the circumferential direction. In FIG. 7, the same components as those shown in FIG. 2 are assigned the same reference numerals, and the descriptions thereof will not be repeated.

According to the present embodiment, at the time of shaving by shuttling each of the outer cutters 10 in the direction of rotation about a central axis 20 within the range of the divided area 10B, the density of the slits that come in contact with skin changes, thereby obviating the danger of damage to the skin. In addition, the number of the slits 65A on the inner peripheral side is smaller than the number of the slits 65A on the outer peripheral side (the former is half the latter in the embodiment illustrated in FIG. 7), thus minimizing the danger of causing damage to skin even if the pressure of contact with skin increases because of the inner shaving face 18A being higher than the outer shaving face 16A.

1. A rotary electric shaver, comprising:
an outer cutter; and
an inner cutter having a blade which rotates in sliding contact with a lower surface of the outer cutter,
wherein an upper surface of the outer cutter has an inner annular shaving face and an outer annular shaving face, wherein the inner annular shaving face is concentrically formed inside the outer annular shaving face, wherein the inner annular shaving face and the outer annular shaving face each include a plurality of hair entry apertures arranged in a plurality of groups, the plurality of groups being arranged in a circumferential direction, wherein within each of the plurality of groups, a distance between consecutive hair entry apertures along the circumferential direction is a different value for each hair entry aperture.

2. The rotary electric shaver according to claim 1, wherein between each of the plurality of groups of hair entry apertures is a blank area having no apertures, a length of the blank are being larger than a largest distance between consecutive hair entry apertures within any of the plurality of groups.

3. The rotary electric shaver according to claim 2, wherein the inner annular shaving face and outer annular shaving face are circumferentially divided into two or more equal segments, each segment containing an entirety of one of the plurality of groups and at least a part of the blank area disposed next to the contained group, and the distance between consecutive hair entry apertures within the segment increases continuously in a clockwise direction.

4. The rotary electric shaver according to claim 1, wherein there are more hair-entry apertures formed per unit arc in the outer annular shaving face than in the inner annular shaving face.

5. The rotary electric shaver according to claim 1, wherein the hair entry apertures are slit-shaped apertures, the slit-shaped apertures include plural common hair-introduction slits which are positioned radially on plural straight lines, wherein the plural straight lines are formed across the inner annular shaving face and the outer annular shaving face, and plural outer periphery non-common hair-introduction slits which are formed in the outer annular shaving face and positioned in between the common hair-introduction slits.

6. The rotary electric shaver according to claim 5, wherein within each of the plurality of groups of hair entry apertures, outermost apertures are common hair-introduction slits.
